(19) United States
(12) Patent Application Publication
(10) Pub. No.: US 2007/0014636 A1
(43) Pub. Date: Jan. 18, 2007

(54) System for storage or transport of compressed gas on a floating structure

(76) Inventors: Kare Breivik, Tau (NO); Ola Ravndal, Sandnes (NO); Svein Inge Eide, Sandnes (NO); Pag G. Bergan, Nesoya (NO); Kare Bakken, Aros (NO)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 10/563,469

(22) PCT Filed: Jul. 1, 2004
(86) PCT No.: PCT/NO04/00200

§ 371 Date: Jun. 12, 2006

(30) Foreign Application Priority Data
Jul. 9, 2003 (NO) 20033149

(51) Int. Cl. F16L 1/12

(52) U.S. Cl. 405/171

(57) ABSTRACT

There is provided a system comprising an assembly for storage or transport of compressed gas on a floating structure (1), wherein the assem+y (3) comprises a plurality of separate, parallel, laying pipes (4) which are closed at both ends and are supported discretely or continuously by a supporting structure (5). The pipes (4) are releaseably attached to the supporting structure (5) only at one end thereof, where the pipes are coupled to a manifold system (˜) for filling or emptying of the pipes, and the supporting structure (5) is arranged to allow unobstructed longitudinal guiding of the pipes (4) in the storage assembly (3), so that the pipes individually or in groups can be introduced to or removed from their operating position in the storage assem+y via openings at the ends of the assem+y located oppositely to said one end. There is also provided a method for installation of pipes on a floating structure having such a storage assem+y, wherein the individual pipes (4) are provided on a production plant and are guided therefrom into the storage assembly, the floating structure being ballasted to a desired draft so that the relevant pipes can be guided directly into the correct position in the storage assembly.

The invention relates to a system comprising an assembly for storage or transport of compressed gas on a floating structure, wherein the assembly comprises a plurality of separate, parallel laying pipes that are closed at both ends and are supported by a supporting structure.

Further, the invention relates to a method for installation of pipes on a floating structure having a storage assembly of the current type.

Today's transport of natural gas is carried out—along with the use of pipelines—by the use of transport ships for liquefied natural gas (LNG). In the recent time, the possibility for transport of compressed natural gas (CNG) has become the subject of increasing interest among the market operators. A number of different CNG transport systems have been developed, based on either high pressure alone, or a combination of pressure and low temperature.

As examples of prior art reference may be made to, for example, U.S. Pat. No. 3,863,460, U.S. Pat. No. 4,846,088 and U.S. Pat. No. 6,584,781.

U.S. Pat. No. 3,863,460 shows a storage assembly comprising a plurality of elongated containers that are rigidly attached and independent with respect to each other, and that are sealed at both ends. An expansion vessel is interconnected commonly with all of the containers for receiving expansion media from each of the containers. Means are provided that are connected commonly to all the containers for discharge and filling of each of the containers, so that the assembly is able to handle great quantities of liquefied gases, liquids and the like.

U.S. Pat. No. 4,846,088 shows a system for transporting compressed gas “over water” or over the deck of a seagoing vessel, in order to vent minor gas leaks to the atmosphere and prevent a gradual concentration of dangerous gases. The storage unit consists of pipes of standard pipeline type.

U.S. Pat. No. 6,584,781 shows a method and a system for transport of compressed gas on a floating vessel. The system is of the type stated in the introduction, the system comprising a plurality of parallel, laying pipes that are closed at both ends and are supported by a supporting structure. The plurality of pipes are connected by means of a manifold, and the gas storage system is designed to operate in the region of the optimum compressibility factor for a given gas composition. It is here an object to provide an optimised system for storage and transport of the compressed gas. In the publication it is stated that the optimum conditions are found by lowering the gas temperature and maintaining the pressure at a point that minimises the compressibility factor.

A main object of the present invention is to provide a system for storage or transport of compressed gas which exhibits an improved cost efficiency and gives an increased security as compared to the currently known CNG transport systems.

Another object of the invention is to provide a system of the current type wherein the storage assembly is arranged as a deck load in order not to interfere with the construction of a floating structure, especially when this is a ship.

Other objects of the invention are to provide a system of the current type which has few valves and gives a simple operation, which is able to be inspected and repaired, which is friendly to maintenance, which enables drainage of liquid accumulations and an efficient emptying of tanks, and which has a long working life.

A further object of the invention is to provide a method for installation of pipes on a floating structure, wherein the pressure gas pipes can be floated directly into and out of the hind part of the storage assembly when this is arranged on a ship.

For the achievement of the stated objects there is provided a system of the introductorily stated type which, according to the invention, is characterised in that the pressure gas pipes are releaseably attached to the supporting structure only at one end thereof, where the pipes are coupled to a manifold system for filling or emptying of the pipes, and that the supporting structure is arranged to allow unobstructed longitudinal guiding of the pipes in the assembly, so that the pipes individually or in groups can be introduced to or removed from their operating position in the assembly via openings at the end of the assembly located oppositely to said one end.

According to the invention there is also provided a method for installation of pipes on a floating structure having a storage assembly according to the invention, where pipes have approximately neutral buoyancy in water, which method is characterised in that the individual pipes are provided in the relevant length at a production plant and therefrom are guided into the water surrounding the floating structure and are floated into the storage assembly, the floating structure being ballasted to a desired draft so that the current pipe can be floated directly into the correct position in the storage assembly.

According to the invention there is also provided a method for installation of pipes on a floating structure having a storage assembly according to the invention, which the method is characterised in that the pipes are located in a storage plant on land and are transferred one by one to a mounting table that is adjusted in vertical and horizontal direction so that the mounting table with the pipe is located in a precisely correct linear position relatively to the relevant introduction channel in the storage assembly, and that the pipe thereafter is pushed or pulled into the storage assembly and ahead to its mounting position in the assembly.

The invention will be further described below in connection with exemplary embodiments with reference to the drawings, wherein

FIGS. 1-3 show a side view, a plan view and an end view, respectively, of a vessel of a single-hull type which is provided with a storage assembly according to the invention;

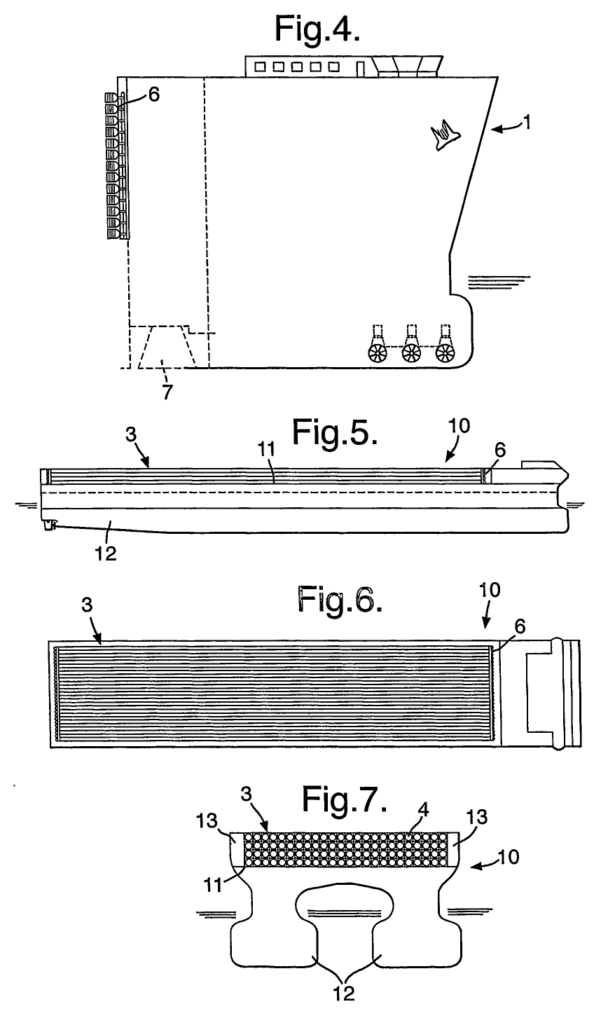

FIG. 4 shows the front portion of the vessel in FIGS. 1-3 on an enlarged scale;

FIGS. 5-7 show a side view, a plan view and an end view, respectively, of a multi-hull vessel which is provided with a storage assembly according to the invention;

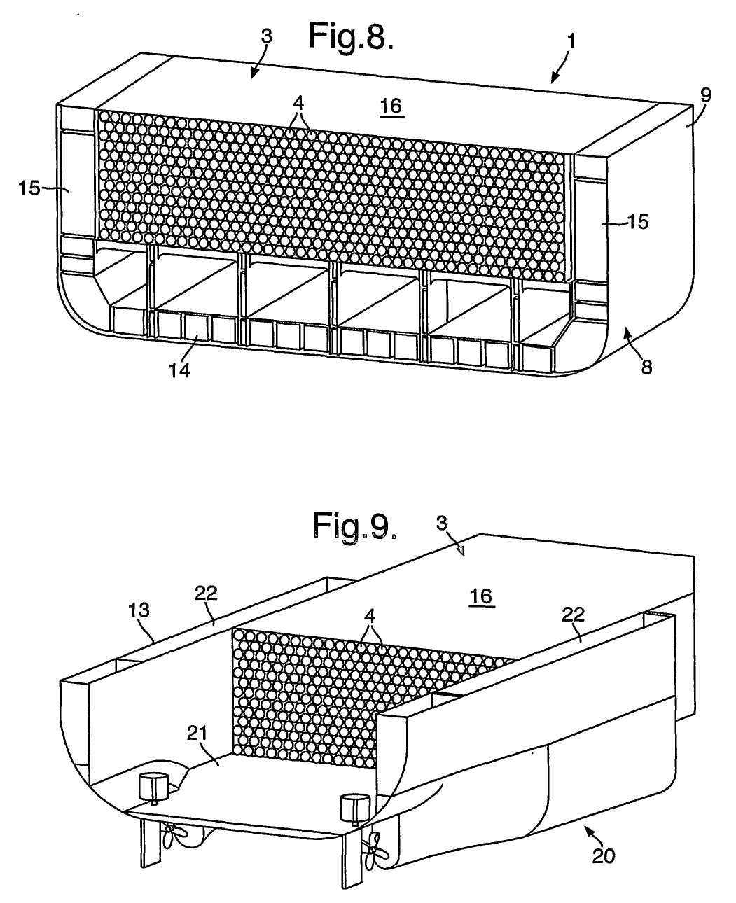

FIG. 8 shows a sectioned perspective view of an example of hull design for a vessel of the type according to FIGS. 1-3;

FIG. 9 shows a partly sectioned perspective view of the rear part of a multi-hull vessel with a partly shown storage assembly;

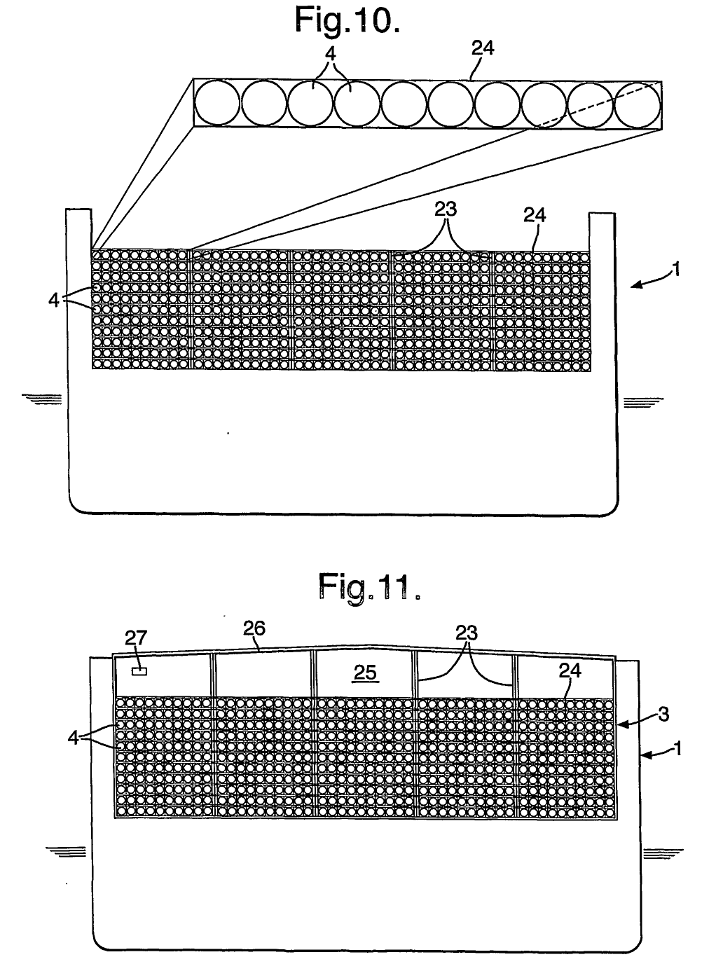

FIG. 10 shows an end view similar to FIG. 3, comprising a pipe-supporting framework which is adapted to receive pipe-receiving cassettes;

FIG. 11 shows an end view similar to FIG. 10, wherein the storage assembly for the pressure pipes in its entirety is arranged in a closed space;

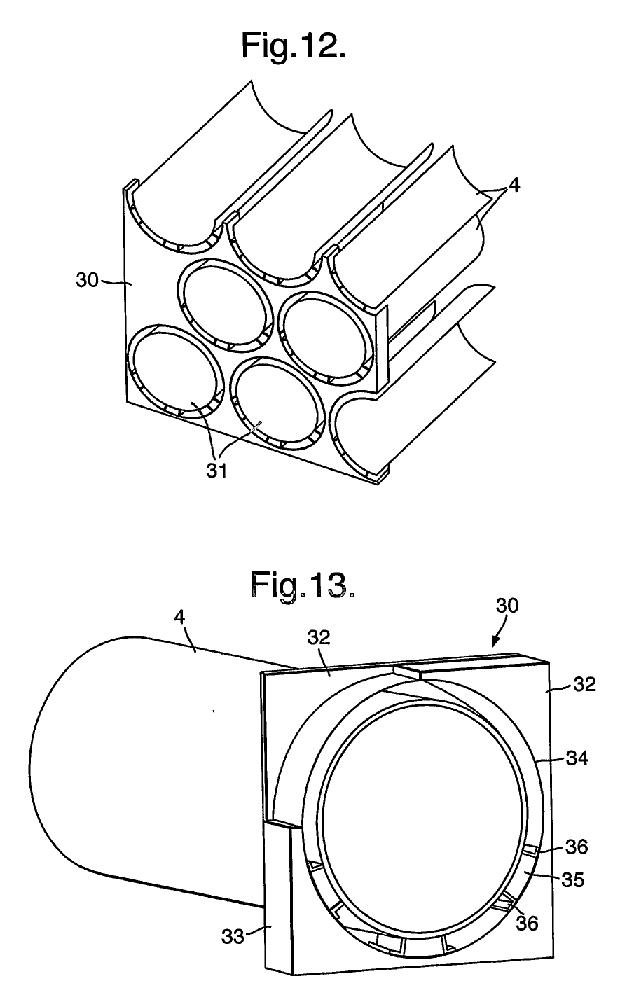

FIG. 12 shows a segment in perspective of a supporting bulkhead that is provided with holes for receiving lining pipes with support blocks for pressure pipes;

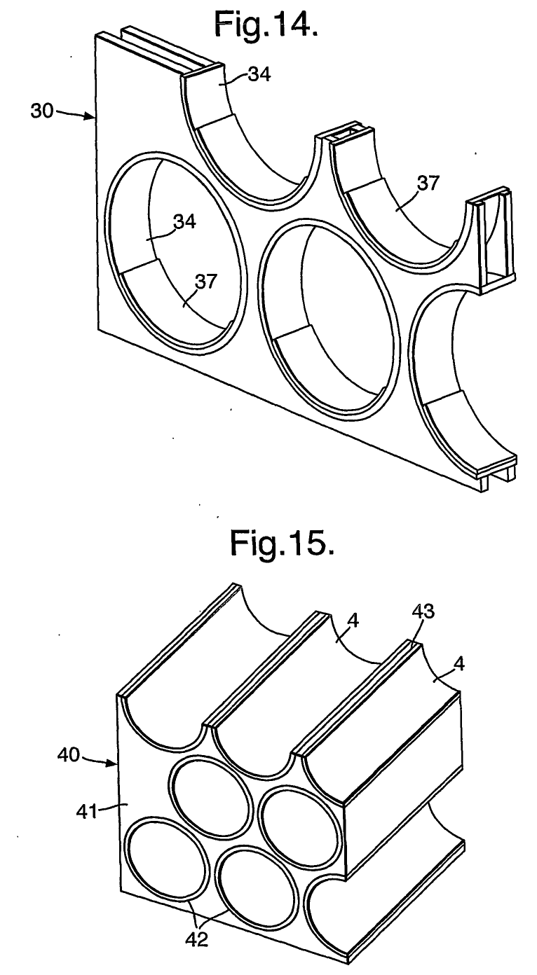

FIG. 13 shows an enlarged segment in perspective of a supporting bulkhead having holes for receiving support pipes with support blocks for a pressure pipe;

FIG. 14 shows an enlarged segment in perspective of a supporting bulkhead;

FIG. 15 shows a segment in perspective of lining pipes in a surrounding light-weight concrete mass;

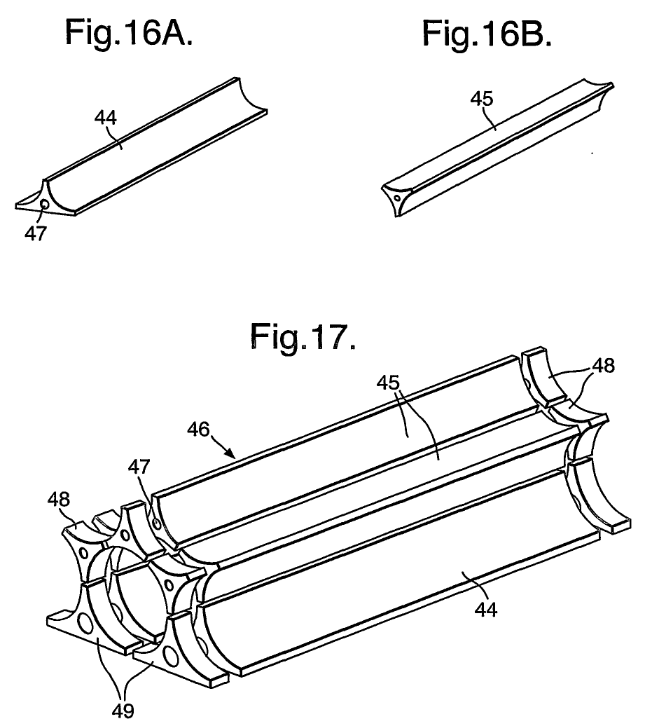

FIGS. 16A-B show respective views of prefabricated concrete elements with a substantially triangular cross-section, for construction of a pipe-supporting supporting structure;

FIG. 17 shows a perspective view of lightweight concrete elements according to FIGS. 16A-B with associated end coupling elements of a more high-grade concrete;

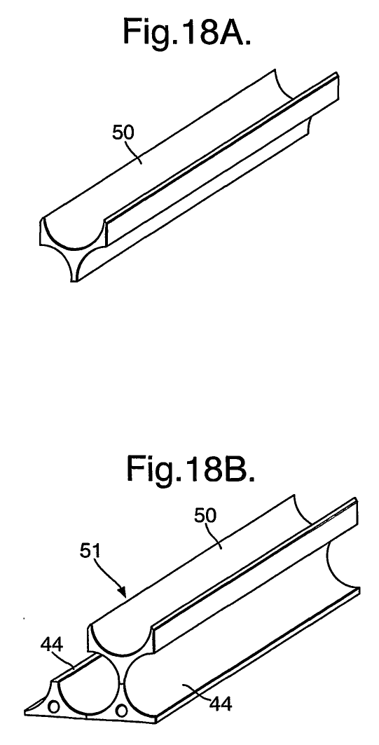

FIGS. 18A-B show perspective views of prefabricated concrete elements having a Y-shaped cross-section;

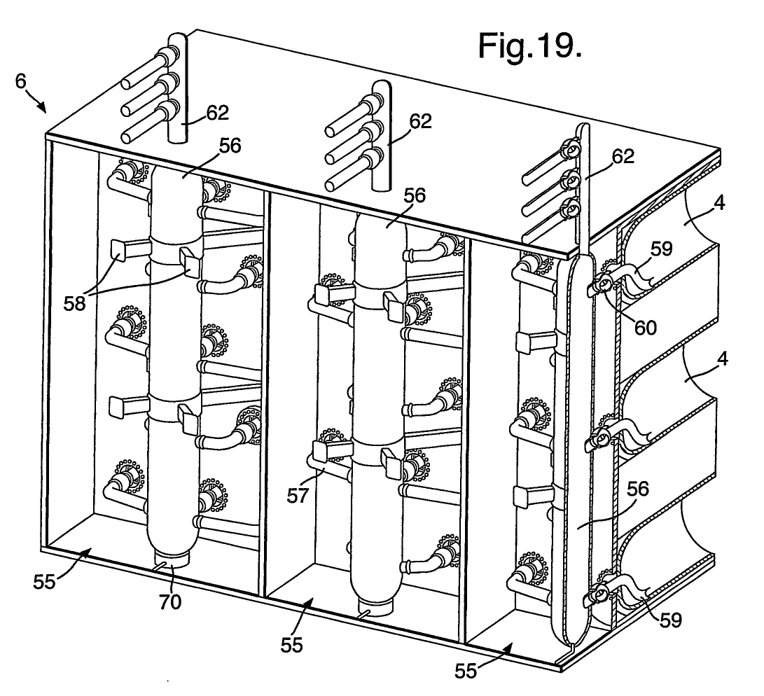

FIG. 19 shows a perspective segment of the manifold system of the storage assembly, wherein there are shown three manifolds spaces of which each contains a vertically extending group manifold to which appurtenant pressure pipes are connected at their forward ends;

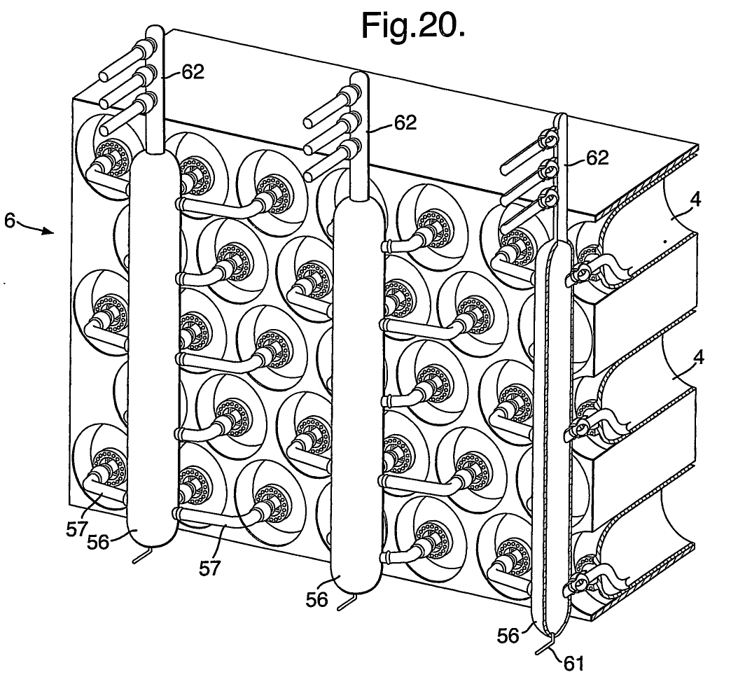

FIG. 20 shows a view similar to FIG. 19, wherein the partitions of the manifold spaces are omitted;

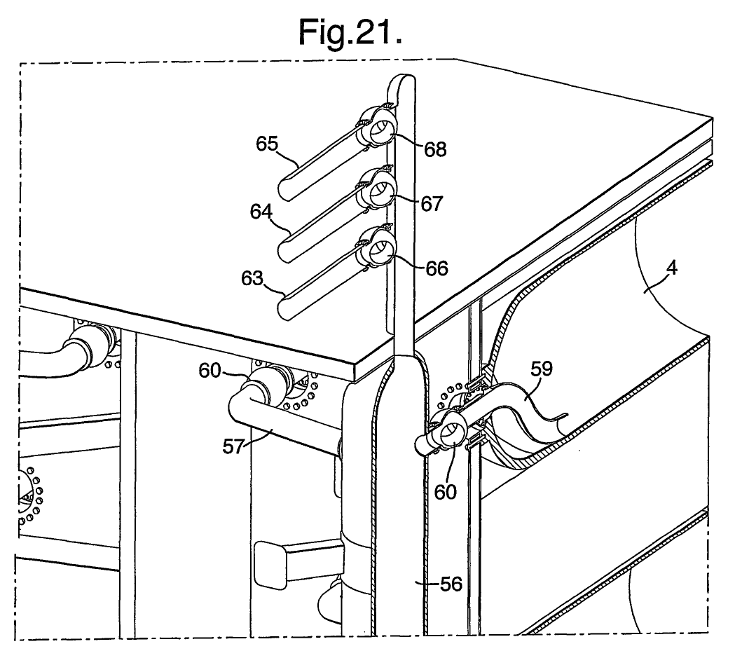

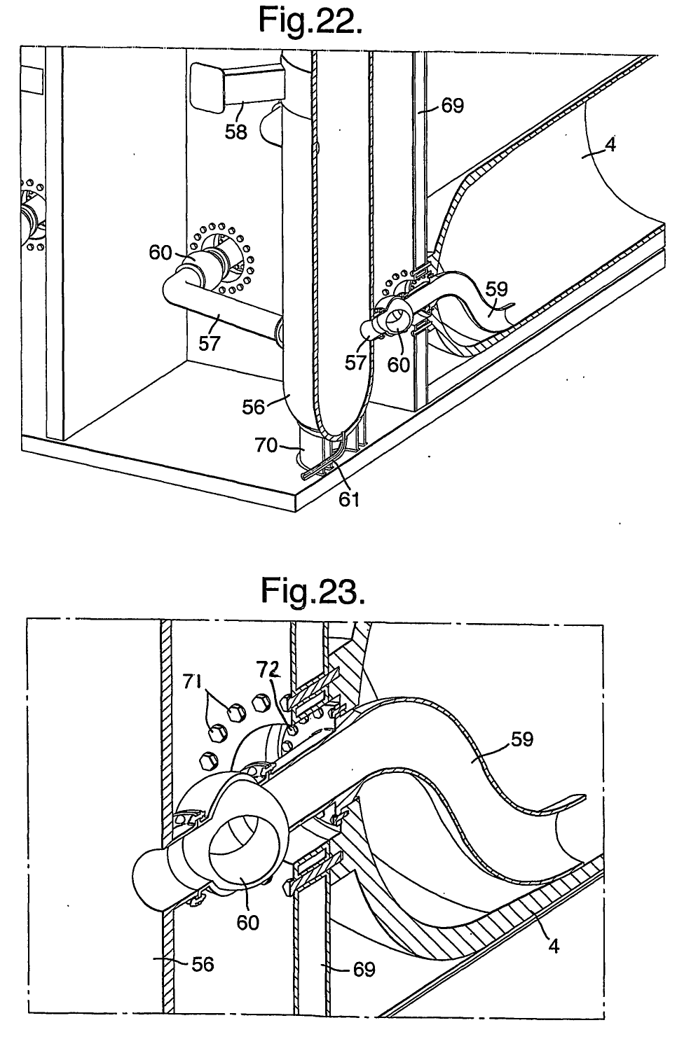

FIGS. 21 and 22 show enlarged detailed views of FIG. 19, of an upper and a lower part, respectively, of a group manifold with connected pressure pipes;

FIG. 23 shows a further enlarged detail of FIG. 21;

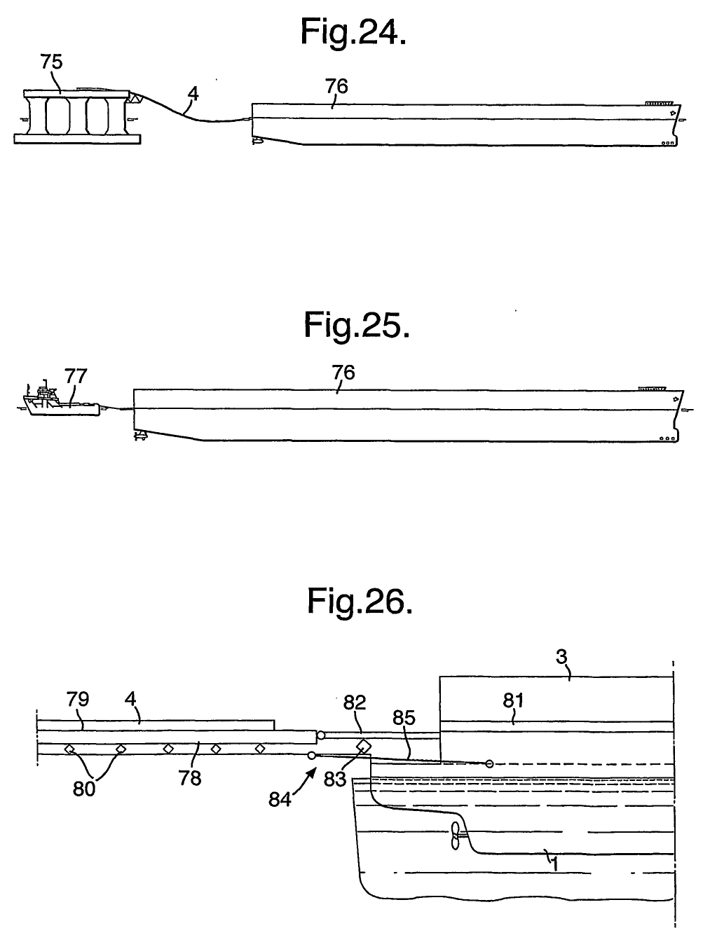

FIG. 24 illustrates a method according to the invention, for installation of pipes in a storage assembly;

FIG. 25 illustrates a method which may be used both by installation and by replacement of pipes in a storage assembly; and

FIG. 26 illustrates a method for installation of pipes produced in a land-based installation.

In the different figures, corresponding parts and elements are designated by the same reference numerals.

In the following description the system according to the invention will be described in connection with transport ships of single-hull and double-hull type, as shown in FIGS. 1-9. It will be clear, however, that the system also can be built and used on other types of floating structures, such as barges and offshore platforms.

FIGS. 1-3 show a side view, a plan view and an end view, respectively, of a single-hull vessel 1 which includes a system according to the invention. It is here the question of a ship which is to have a large deck area and a large deck length. The ship may, for example, have a length of 395 m and a width of 70 m, so that one may obtain as long, straight pipe lengths as possible stacked on the deck of the ship. On the deck 2 there is arranged a storage assembly 3 in the form of a stack of pipes 4 which are closed at both ends and which, in the shown embodiment, include 546 pipes having a length of 350 m and a diameter of 48″. This gives a loading capacity of ca. 200 000 m³ of gas. The ship must have a sufficient stability and displacement to carry very large deck loads in a safe manner, as it may be the question of deck loads of up to 250 000 tons for the largest structures.

The storage assembly 3 is placed in its entirety on the deck 2 in order to avoid integration of cargo-containing units in the very ship structure. This is an advantage in order to keep the complexity level at an acceptable level during the building of the vessel.

The pipes in the storage assembly 3 are supported by a supporting structure 5 which may be constructed in different ways and, for example, may consist of a steel framework, as suggested in FIG. 3. Various advantageous embodiments of the supporting structure will be further described later. In the supporting structure according to the invention the pipes 4 are releaseably attached in relation to the ship only at the forward end of the supporting structure, i.e. at the forward end of the ship. The pipes are here coupled to a manifold system 6 for filling or emptying of the pipes. The supporting structure 5 is constructed so as to allow unobstructed longitudinal guiding of the pipes 4 in the storage assembly, so that the pipes individually or in groups can be introduced to or removed from their operating position in the assembly via openings at the rearward end of the assembly, i.e. at the stem of the ship.

Since the pipes are attached relatively to the supporting structure only at their forward ends, and in other respects are slidably supported by the supporting structure, the pipes may expand or contract freely in the longitudinal direction, and also radially, in case of pressure and temperature changes occurring during operation of the system.

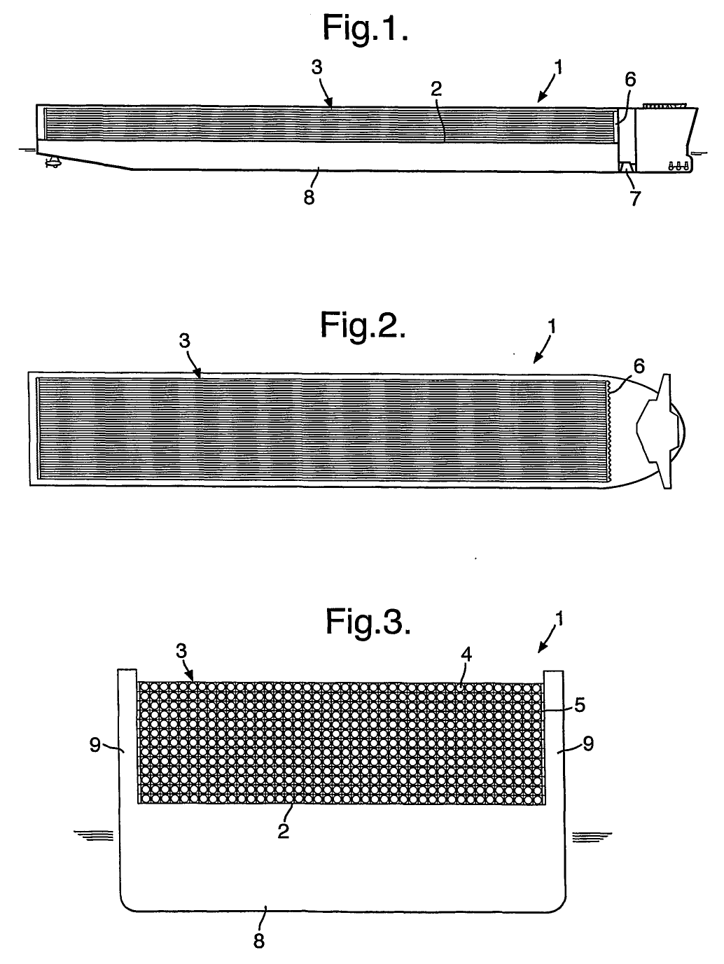

The manifold system 6, which is suggested in FIGS. 1 and 2, is shown on a somewhat enlarged scale, but still schematically, in FIG. 4. This system will be further described with reference to FIGS. 19-23.

As appears from FIGS. 1 and 4, the ship 1 at the bottom is provided with downwardly open receiving space 7 for a so-called STL (Submerged Turret Loading) buoy (not shown). During operation the ship thus can receive an STL buoy which may be coupled to the manifold system, so that the pipes in the storage assembly can be filled or emptied via the buoy.

FIGS. 5-7 show a side view, a plan view and an end view, respectively, of a double hull vessel 10 of the catamaran type, wherein the vessel includes a system according to the invention. This vessel typically may have a length of 190 m and a width of 40 m and a displacement of ca. 37 000 tons. This gives a loading capacity of ca. 18 000 m³ of compressed gas. The speed of the vessel may be ca. 25 knots, versus typically ca. 15 knots for a vessel according to FIGS. 1-3.

In a similar manner as on the vessel 1, on the deck 11 of the vessel 10 there is arranged a storage assembly 3 in the form of a stack of pipes 4 extending from the forward to the rearward end of the vessel, and which at the forward ends are coupled to a manifold system 6. The pipes are supported by a supporting structure which may be of a design similar to the designs taken into consideration in the vessel according to FIGS. 1-3 (see FIGS. 8, 12 and 15).

As regards the pipes 4, these are—as mentioned—closed at both ends, for example by means of hemispherical end pieces. The end pieces suitably may be provided with attachment collars for mounting of towing/handling equipment. At their forward ends the pipes are coupled to suitable valves which in turn are coupled to the manifold system, and at their rearward ends the pipes suitably are provided with safety valves for emergency blowout, and with suitable openings for inspection access. Such blowout alternatively may be carried out at the pipe equipment at the forward end. The pipes themselves may be manufactured of steel or of a suitable composite material, or of a combination of these materials. When the pipes are empty, they will have an approximately neutral buoyancy in water.

As appears from FIGS. 3 and 7, the hull 8 of the vessel 1 is provided with sidewall-forming hull parts 9, whereas the double hull 12 of the vessel 10 is provided with sidewall-forming hull parts 13. The supporting structure 5 for the pipes 4 in each storage assembly 3 is constructed such that it forms a structurally rigid block which is connected to the deck and the sidewall parts of the hull of the vessel, so that it may contribute to the total rigidity and strength thereof.

FIG. 8 shows a sectioned perspective view of a part of the vessel 1 according to FIGS. 1-3, and shows an example of hull design. As appears, the hull 8 is provided with a double bottom 14 and with double-walled hull sides of which upper portions constitute the sidewall members 9. The sidewall members are shaped with a number of ballast tanks 15 enabling submersion of the vessel, so that the pipes 4 at selected levels of the supporting structure may be made floating with a view to assembly or disassembly of the pipes. In the embodiment of FIG. 8, the pipes 4 are supported by a supporting structure 16 s which is different from the supporting structure 5 on the vessel according to FIGS. 1-3. In this embodiment the pipe-receiving openings are arranged in a hexagonal pattern, as further described in connection with FIGS. 12-15.

FIG. 9 shows a partly sectioned perspective view of the rearward part of a double-hull vessel 20 wherein, on the deck 21 of the vessel, there is arranged a partly shown storage assembly 3 containing pipes 4 which are placed in a similar supporting structure 16 as in FIG. 8. The sidewall members 13 of the vessel are provided with ballast tanks 22 in a manner similar to FIG. 8.

As mentioned, the supporting structure for the pipes may be constructed in different ways. In the embodiments of FIGS. 1-4 and FIGS. 5-7, the supporting structure comprises a number of transversely extending frameworks or racks (not further shown in these figures) that are arranged at suitable intervals along the length of the pipes, and which comprise supporting elements forming cells or openings for reception of weight and support of individual pipes. As appears from FIGS. 3 and 7, the supporting elements in this manner form cells/openings in a rectangular pattern.

FIGS. 10 and 11 show cross-sections of the vessel 1 with storage assemblies wherein the supporting structures are constructed as discussed above, with transversely extending frameworks forming pipe-receiving openings in a rectangular pattern. In this embodiment, however, the frameworks are divided into a number of sections located next to each other and being separated by vertical dividing elements 23, so that each section comprises a number of spaces for receiving cassettes 24 that are releaseably mounted in the supporting structure. In the final structure the cassettes will constitute the supports, such as previously described. Each of the cassettes receives a plurality of pipes (ten pipes in the shown example) that are located next to each other on a suitable support in each cassette. Thus, groups of pipes simultaneously may be introduced into or removed from the storage assembly. By means of the cassette arrangement the individual pipes in the cassette may be connected to a small cassette manifold before they are coupled to a main manifold via a single valve. The advantage of this will be to reduce to a great extent the number of valves normally operated during loading operations, as well as simplifying the floating of pipes into and out of the storage assembly, as further described later.

In the embodiment of FIG. 10, as in the embodiments described above, the storage assembly is shown to be upwardly open to the atmosphere. In case of a possible leakage from the pressure gas pipes, the leaking gas then will escape to the surrounding atmosphere. For safety reasons, this in some cases may be undesirable. In such cases it will be advantageous to build in the entire storage assembly in a closed space.

Such an embodiment is shown in FIG. 11 wherein the storage assembly is located in a closed space 25 which is closed upward by means of a roof-forming plate element 26.

The closed space 25 suitably may be provided with one or more sensors 27 for the detection of a possible gas leakage from the pipes. Further, the space may be thermally insulated from the surroundings and possibly be provided with means for cooling of the interior of the space.

It is to be remarked that, in some applications of the system according to the invention, it may be of interest to transport gas partly in liquid state. This is due to the fact that some of the gas, more specifically heavy components, such as butane, may be condensed out as liquid.

In the closed embodiment according to FIG. 11, at the rearward end of the pipes there will be arranged a gate means (not shown) that can be opened by installation and/or replacement of individual pipes or groups of pipes. Instead of a gate means, there may possibly be arranged a replaceable means for said purpose. In embodiments wherein the is storage assembly is not enclosed, there will normally be arranged a protective wall at the rearward end of the pipes, for protection against waves and other weather influence. Also such a protective wall will be provided with a suitable gate means for the above-mentioned purpose.

FIGS. 12-18 show examples of alternative embodiments of supporting structures for the pressure gas pipes in the storage assembly according to the invention. The shown embodiments are of two fundamentally different types, more specifically structures having a discrete support arrangement for the pipes (FIGS. 12-14), and structures having a continues support arrangement for the pipes (FIGS. 15-18).

FIG. 12 shows a perspective segment of a support bulkhead 30 which is provided with openings 31 for receiving and supporting individual pipes 4. In a similar manner as in FIGS. 8 and 9, the openings 31 in the bulkheads 30 are arranged in a hexagonal pattern, which gives a somewhat tighter packing of the pipes 4 in the storage assembly than in the embodiment of FIG. 3 wherein the pipe-receiving openings are formed in a rectangular pattern. The support bulkheads 30 are arranged at suitable intervals along the length of the pipes 4, and provide for a discrete support of the pipes.

The bulkheads are built as a sandwich structure consisting of perforated steel plates 34 with an intermediate mass 33 of concrete, as appears from FIG. 13. In each opening 31 there is placed a support pipe 34 defining the opening. In the lower portion of each support pipe there is shown to be placed three support pads or blocks 35 of a low-friction material, for slidable support of the pipes 4. The support blocks are placed in block guides 36. Possibly, there may be used two or more support blocks.

FIG. 14 shows a perspective view similar to FIG. 12, but the support blocks in each opening here are replaced by a single low-friction sliding element 37 in the lower portion of the support pipe 34.

The support pipes with appurtenant sliding elements possibly may be extended so as to extend outside of the support bulkheads 30 at each side thereof. At the end of the extended support pipes facing the stem of the ship, the support pipes possibly may be shaped with funnel-shaped lead-in portions, to facilitate introduction of the pressure gas pipes when installing these in the storage assembly.

FIG. 15 shows a perspective segment of a supporting structure 40 which is solid and substantially fills the intermediate spaces between the pipes in the assembly, and which provides for continuous support of the pipes along the entire length thereof.

The supporting structure 40 consists of a mass 41 containing longitudinally extending, parallel passages or holes 42 for receiving and supporting the individual pipes 4. Each of the holes in its entire length is carried by a thin-walled lining pipe 43 which preferably sticks to the surrounding mass and which has an inner diameter that is somewhat larger than the outer diameter of the pipes 4, so that the pipes 4 are freely slidable in the lining pipes 43 and possibly also may expand radially therein in case of occurring pressure and temperature changes. The lining pipes may consists of thin-walled steel pipe, a composite material or another material, wherein the lower portion of the inner side of the pipes may be provided with a suitable low-friction coating.

Also in this embodiment the pipe-receiving holes 42 are shown to be arranged in a hexagonal pattern, with a view to tight packing of the pressure gas pipes.

The compact mass 41 in the supporting structure preferably consists of a non-combustible soil material (geo-material), such as a suitable concrete material, preferably light concrete. The mass may by cast in situ or may be formed from prefabricated elements, preferably of light concrete, which are shaped so that they, in the assembled condition, form the topical passages/holes for reception of the pressure gas pipes.

Examples of such prefabricated elements are shown in FIGS. 16-18. Thus, FIGS. 16A-B show two elements 44 and 45 of which both have a substantially triangular cross-section, wherein the element 44 in FIG. 16A has one planar and two curved side surfaces, whereas the element 45 in FIG. 16B has three curved side surfaces. A number of these elements may be assembled to a unit 46 providing a longitudinally extending passage for the reception of a pipe, as shown in FIG. 17. The unit 46 has curved side surfaces for the formation of additional pipe-receiving passages/holes when assembled with similar elements. As shown, the elements 44, 45 are also provided with longitudinal holes 47 for weight reduction, or for mounting of service equipment (e.g. cooling elements or leakage detectors).

In FIG. 17 there are also shown coupling elements 48, 49 for interconnecting the ends of adjacent units 46, for building up a supporting structure having a length corresponding to the length of the current storage assembly. As an alternative, the units may be fixed to each other by gluing or other forms of mechanical binding.

FIG. 18A shows another embodiment of a prefabricated element 50 having a substantially Y-shaped cross-section. As appears from FIG. 18B, two such elements may be assembled with two elements 44 according to FIG. 16A, for the formation of a unit 51 corresponding to the unit 46 in FIG. 17.

Such prefabricated elements may also have other cross-sectional shapes, such as double triangular shape, Z-shape, etc.

The above-mentioned embodiments wherein the pressure gas pipes are continuously supported by thin-walled lining pipes surrounded by a matrix of light concrete or the like, implies a number of essential advantages of which some are to be mentioned below.
The use of a compact mass around the lining pipes in the storage assembly satisfies the fire integrity demands for protection of the cargo, i.e. the compressed gas in the pipes, against an external fire.
Only a little gap between the lining pipe and the pressure gas pipe needs to be filled with inert gas.
Since all pipes are contained in a lining pipe that can be closed at both ends, it is simple to carry out continuous monitoring of leakages on individual pipes by the use of gas or pressure sensors.
If a larger crack should arise in a pressure pipe, the gas flow will hit the wall of the lining pipe, and the gas flow may be guided through a blowout opening at the rearward end of the lining pipe.
The mass between the lining pipes has a good ability for energy absorption, something which protects the pressure pipes in connection with collision or explosion.
All local, static and dynamic stresses from supports are practically eliminated. As a result of the sliding supports, also bending stresses caused by global bending of the vessel hull, become low.
The rigidity and strength of the storage assembly, consisting of steel lining pipes and concrete, is integrated in the hull, so that the steel weight of the hull may be reduced.

FIGS. 19-23 show details of the manifold system 6 that is arranged at the forward end of the storage assembly 3, as mentioned above in connection with FIGS.1-4.

In principle, the manifold system comprises at least one closed manifold space which, at the rearward end, is defined by an end wall to which the adjacent ends of the pressure pipes are releaseably attached. In the embodiment shown in FIGS. 19 and 20, the starting point has been taken in a storage assembly comprising five levels of pressure pipes 4, wherein the pipes also here are arranged in a hexagonal pattern, as appears from FIG. 20. In the partly 'sectioned perspective view of FIG. 19 there are shown three closed manifold spaces 55 (the front wall is omitted in the figure) of which each contains a vertically extending, pipe-like container 56 forming a group manifold, groups of pipes 4 situated above each other being connected to an appurtenant group manifold 56 via valve-equipped pipe lengths 57. The manifold containers are kept in place by means of support brackets 58 fastened to the walls of the manifold space, and in other respects rest on a support structure 70.

As appears, each of the pipes 4 at its forward end is provided with an internal drain pipe 59 which, through a ball valve 60, passes into the above-mentioned pipe length 57 which is connected to the group manifold 56. The drain pipes provide for emptying of a possible collected liquid (condensed gas) from the pipes, a suitable forward trim of the vessel being provided in connection with a drainage operation, so that the liquid collects at the forward end of the pressure pipes.

At their lower end the manifold containers 56 are provided with a drain pipe 61 for emptying of collected liquid.

At its upper end each manifold container 56 further is provided with an outlet pipe 62 to which there are shown to be connected three branch pipes 63, 64, 65 via respective ball valves 66, 67, 68. Normally, two of these pipes may be used for filling and emptying the pipes 4 in the storage assembly, whereas the third pipe may provide a blowout possibility for the group manifold in question.

The above described details are more clearly shown in the enlarged views in FIGS. 21-23. Especially referring to FIG. 23, the shown pressure pipe 4 is releaseably attached to the rearward wall 69 of the topical manifold space by means of a number of screw bolts 71 which are carried through the wall 69 and are screwed on in the adjacent, hemispherical and portion of the pipe 4. The drain pipe 59 is shown to be fastened to the pipe 4 by means of a number of screw bolts 72 which are carried through a ring flange on the drain pipe and screwed on to the end of the pipe 4.

Advantageous methods for installation of pipes on a floating structure having a storage assembly constructed as described above, are illustrated in FIGS. 24-26, wherein the floating structure is a ship.

FIG. 24 illustrates a method wherein the individual pipes are provided in the relevant length at a production plant in the form of a pipe-laying vessel 75, and therefrom are guided into the water surrounding the ship 76 and are floated directly into the storage assembly on the ship, the ship being ballasted to a desired draft, so that the relevant pipe can be floated directly into the correct position in the storage assembly. The pipes are provided for example by successive welding together of suitable pipe lengths on a pipe-laying vessel which, for example, may be a barge. It is clear, however, that the pipes also may be provided in the relevant length at a land-based plant, and then possibly be transported ahead to the topical vessel.

FIG. 25 illustrates a method which may be used both by installation and by replacement of pipes. The figure shows how individual pipes, or cassettes of pipes, may be floated into or out of the storage assembly by means of a towboat/tug 77, the ship 76 also in this case being ballasted to the desired draft.

FIG. 26 illustrates a method wherein the pressure pipes 4 are produced in a land-based plant and are transferred directly to the storage assembly 3 by means of a mounting device suitable for the purpose. The mounting device includes a mounting table 78 on which the pressure pipes 4 are placed in the extension of the stern of the vessel 1. The mounting table 78 has a length corresponding at least to the length of the pressure pipes, and along its entire length it is equipped with rollers or sliding surfaces 79, so that the pressure pipes can be guided in the axial direction into the storage assembly 3. The mounting table 78 further is provided with hydraulic or mechanic devices 80, so that the longitudinal axis of a pressure pipe 4 which is to be introduced into a lead-in channel 81 in the storage assembly 3, corresponds exactly with the axis of the position of the storage assembly into which the pipe is to be guided. The device further is shown to be equipped with an adjustable transfer element or a bridge 82 spanning between the mounting table 78 and the correct position in the storage assembly. The adjusting possibility is illustrated by 83 in the Figure. Further, the Figure shows an adapted quay means 84 and a pre-stressed or rigid mooring means 85 allowing movement of the vessel 1 according to tidal changes and ballasting of the vessel.

1. A system comprising an assembly for storage or transport of compressed gas on a floating structure (1; 10), wherein the assembly (3) comprises a plurality of separate, parallel laying pipes (4) which are closed at both ends and are supported by a supporting structure (5; 40), characterised in that the pipes (4) are releaseably attached to the supporting structure (5; 40) only at one end thereof, where the pipes are coupled to a manifold system (6) for filling or emptying of the pipes, and that the supporting structure (5; 40) is arranged to allow unobstructed longitudinal guiding of the pipes (4) in the assembly (3), so that the pipes individually or in groups can be introduced to or removed from their operating position in the assembly (3) via openings at the end of the assembly located oppositely to said one end.

2. A system according to claim 1, characterised in that the supporting structure (40) is solid and substantially fills the intermediate spaces between the pipes (4) in the assembly, the pipes being placed in individual holes (42) in the supporting structure and being continuously supported by the supporting structure (40) along their entire length.

3. A system according to claim 2, characterised in that the holes (42) in the supporting structure (40) in their entire length are clad by thin-walled lining pipes (43) sticking to the supporting structure and having an inner diameter that is somewhat larger than the outer diameter of the pipes (4).

4. A system according to claim 2, characterised in that the supporting structure (40) comprises non-combustible geo-material.

5. A system according to claim 4, characterised in that the supporting structure (40) comprises cast lightweight concrete.

6. A system according to claim 4, characterised in that the supporting structure (40) consists of prefabricated lightweight concrete elements (44,45).

7. A system according to claim 1, characterised in that the supporting structure (5) comprises a steel framework comprising a number of racks arranged at intervals along the length of the pipes (4) and comprising support elements extending horizontally and vertically transversely to the pipes, so that they form cells for receiving and supporting individual pipes (4).

8. A system according to claim 1, characterised in that the supporting structure comprises a number of bulkheads (30) arranged at intervals along the length of the pipes (4) and extending transversely thereto, the bulkheads being provided with openings (31) for receiving and supporting individual pipes (4).

9. A system according to claim 8, characterised in that each of the bulkheads (30) is constructed as a sandwich structure consisting of perforated steel plates (32) with intermediate concrete (33).

10. A system according to claim 7, characterised in that each of the pipes (4) in assembled condition is surrounded by thin-walled lining pipes (43) having an inner diameter that is somewhat larger than the outer diameter of the pipes (4).

11. A system according to claim 1, characterised in that groups of pipes at the same horizontal level in the supporting structure (5) are placed in respective cassettes (24) that are releaseably mounted in the storage assembly (3).

12. A system according to claim 1, characterised in that the supporting structure (40) forms a structurally rigid block arranged at a deck on the floating structure (1; 10), and which constitutes an integrated part of the floating structure and contributes to the total rigidity and strength thereof.

13. A system according to claim 12, characterised in that the floating structure is an elongated vessel (1) of the single-hull type, wherein the storage assembly (3) is arranged on the deck (2) of the vessel between sidewall-forming parts (9) of the hull (8), the pipes (4) in the block extending parallel to the longitudinal axis of the vessel (1) from a forward to a rearward end of the vessel.

14. A system according to claim 12, characterised in that the floating structure is an elongated multi-hull vessel (10), wherein the storage assembly (3) is arranged on a common deck (11) between sidewall-forming parts (13) of the hull (12), the pipes (4) in the block extending parallel to the longitudinal axis of the vessel (10) from a forward to a rearward end of the vessel.

15. A system according to claim 13, characterised in that at least the sidewall-forming parts (9; 13) of the hull contains ballast tanks (15; 22) enabling submersion of the vessel (1; 10), so that the pipes (4) at selected levels of the block may be made floating with a view to mounting or dismounting of the pipes.

16. A system according to claim 13, characterised in that the manifold system (6) is located at the forward end of the vessel (1; 10) and is arranged in at least one closed manifold space (55) having a rearward end wall (69) to which the adjacent ends of the pipes (4) are releaseably attached.

17. A system according to claim 16, characterised in that vertical groups of pipes (4) are coupled to an appurtenant, vertically extending group manifold (56) having a blowout possibility (62) to the surroundings in the upwards direction.

18. A system according to claim 13, characterised in that the pipes (4) at least at one end are provided with a safety valve and a pipe means for emergency blowout.

19. A system according to claim 13, characterised in that the storage assembly (3) is built into a closed space (25) which is thermally insulated from the surroundings and provided with means for cooling of the interior of the space.

20. A system according to claim 19, characterised in that the closed space (25) at the rearward end of the pipes (4) is provided with a gate means which can be opened in case of installation and/or replacement of individual pipes (4) or groups of pipes.

21. A system according to claim 16, characterised in that the pipes (4) at their forward end are provided with an internal drain pipe (59) debouching into the manifold space (55), and which is arranged for emptying of a possible collected liquid from the pipes (4), in conjunction with a moderate forward trim of the vessel (1; 10).

22. A method for installation of pipes on a floating structure having a storage assembly according to claim 1, wherein the pipes (4) have an approximately neutral buoyancy in water, characterised in that the individual pipes (4) are provided in the relevant length on a production plant (75) and therefrom are guided into the water surrounding the floating structure (76) and are floated into the storage assembly, the floating structure being ballasted to a desired draft so that the relevant pipe can be floated directly into the correct position in the storage assembly (3).

23. A method according to claim 22, characterised in that the pipes (4) are provided by successive welding-together of suitable pipe lengths on a pipe-laying vessel (75).

24. A method according to claim 22, characterised in that a number of the provided pipes (4) are placed in a cassette (24) which is floated in place at a desired level in the storage assembly (3).

25. A method according to claim 22, when replacing pipes in the storage assembly, characterised in that the floating structure (76) is ballasted to the desired draft, and the relevant pipe or pipes is/are pulled out from the storage assembly by means of a towboat (77).

26. A method for installation of pipes on a floating structure having a storage assembly according to claim 1, characterised in that the pipes (4) are located in a storage plant on land and are transferred one by one to a mounting table (78) which is adjusted in vertical and horizontal direction so that the mounting table with the pipe is situated in the exactly correct linear position in relation to the relevant lead-in channel (81) in the storage assembly (3), and that the pipe (4) thereafter is pushed or pulled into the storage assembly and ahead to its mounting position in the assembly.
